(19) United States
(12) Patent Application Publication
(10) Pub. No.: US 2026/0274635 A1
(43) Pub. Date: Sep. 17, 2026

(54) TOOL FOR REMOVING A POLE FROM THE GROUND

(71) Applicants: Robert Christian REED, Blue Mountain, MS (US); Kevin Lee ORMAN, Ripley, MS (US)

(72) Inventors: Robert Christian REED, Blue Mountain, MS (US); Kevin Lee ORMAN, Ripley, MS (US)

(21) Appl. No.: 19/078,060

(22) Filed: Mar. 12, 2025

(51) Int. Cl. B66F 19/00

(52) U.S. Cl. CPC B66F 19/00

(57) ABSTRACT

Embodiments of a tool for removing a pole from the ground and a method for removing a pole from the ground are provided herein. In some embodiments, a tool for removing a pole from the ground includes a rod having a first end and a second end, wherein the rod includes first threads at the first end that are configured for penetrating the utility pole and securing the rod to the pole; a drive feature coupled to the rod proximate the second end; and a hook coupled to the rod at the second end.

### FIELD

Embodiments of the present disclosure generally relate to tools, and more specifically, to tools that aid in pulling objects.

### BACKGROUND

Utility poles are structures, typically made of wood, steel, or concrete, that support overhead utility lines such as electricity, telecommunication, or cable wires. These poles are installed deep into the ground, often several feet, to ensure they remain stable and can support the weight of the wires and withstand environmental factors like wind and storms.

When utility poles need to be removed, usually due to maintenance, upgrades, or decommissioning, the process typically involves digging around the base of the pole. The purpose of digging is to expose the pole's footing or anchor, which is usually embedded in the soil or concrete. Once the ground around the pole is loosened and cleared, the pole can be either pulled out with machinery or disassembled. However, digging around the base of the pole may damage underground utility lines or conduits and thus may be a safety concern. Additionally, digging around the base of the pole may require more work to fill the hole once the pole is removed.

Accordingly, the inventors have provided herein embodiments of a tool for removing a pole from the ground and improved methods for removing a pole from the ground with minimal disruption to underground utilities located in the same area.

### SUMMARY

Embodiments of a tool for removing a pole from the ground and a method for removing a pole from the ground are provided herein. In some embodiments, a tool for removing a pole from the ground includes a rod having a first end and a second end, wherein the rod includes first threads at the first end that are configured for penetrating the utility pole and securing the rod to the pole; a drive feature coupled to the rod proximate the second end; and a hook coupled to the rod at the second end.

In some embodiments, a tool for removing a utility pole from the ground includes: a rod having a first end and a second end, wherein the rod includes first threads at the first end having a pointy end configured for penetrating the utility pole, and wherein the rod includes second threads at the second end, wherein the first threads extend at a first angle with respect to an axis of the rod and the second threads extend at a second angle with respect to the axis of the rod, wherein the first angle is different than the second angle; a nut coupled to the rod proximate the second end via the second threads; and an eye nut removably coupled to the rod at the second end.

In some embodiments, a method of removing a pole from the ground includes coupling a tool having a rod that includes a threaded first end into the pole; and pulling the rod from a hook disposed at a second end of the rod, opposite the first end, to remove the pole from the ground.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 depicts a side view of a tool for removing a pole from the ground in accordance with at least some embodiments of the present disclosure.

FIG. 2 depicts a flow chart of a method of removing a pole from the ground in accordance with at least some embodiments of the present disclosure.

FIG. 3A depicts a schematic side view of a pole in the ground in accordance with at least some embodiments of the present disclosure.

FIG. 3B depicts schematic side view of a pole after drilling a pilot hole in the pole in the ground in accordance with at least some embodiments of the present disclosure.

FIG. 3C depicts a schematic side view of a pole in the ground after attaching a tool to the pole in accordance with at least some embodiments of the present disclosure.

FIG. 3D depicts a schematic side view of a pole being removed from the ground in accordance with at least some embodiments of the present disclosure.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of a tool for removing a pole from the ground and a method for removing a pole from the ground are provided herein. The tool advantageously attaches to the pole to be removed and has a hook for pulling the pole out of the ground. Pulling the pole out of the ground advantageously provides a safer method of removing the pole as compared to digging around the base of the pole. Also, pulling out the pole from an old hole and placing a new pole in the old hole advantageously allows for reuse of the old hole without a need to form or auger a new hole. Forming a new hole can risk damage to nearby underground utility lines. In the case where the pole is a utility pole, the tool advantageously includes features that enable a utility technician to secure the tool the pole and pull the pole out of the ground with generally available drills, machines, vehicles, and the like.

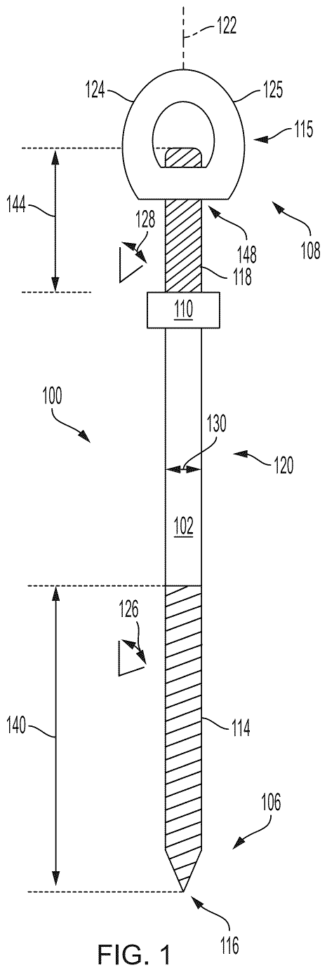

FIG. 1 depicts a side view of a tool for removing a pole from the ground in accordance with at least some embodiments of the present disclosure. The tool 100 includes a rod 102 having a first end 106 and a second end 108 disposed opposite the first end 106. The rod 102 includes first threads 114 at the first end 106 that are configured for penetrating the utility pole and securing the rod to the pole (e.g., screw threads). In some embodiments, the first end 106 includes tapered sidewalls that, for example, create a point 116 configured for penetrating the utility pole.

In some embodiments, the rod 102 includes second threads 118 at the second end 108. In some embodiments, the first threads 114 extend at a first angle 126 with respect to an axis 122 of the rod 102. The first angle 126 may generally be greater than zero and less than 90 degrees. In some embodiments, the second threads 118 extend at a second angle 128 with respect to the axis 122 of the rod 102. The second angle 128 may generally be greater than zero and less than 90 degrees. In some embodiments, the first angle 126 is different than the second angle 128. In some embodiments, the first threads 114 extend along a first length 140 of the rod 102. In some embodiments, the second threads 118 extend along a second length 144 of the rod 102. In some embodiments, the second length 144 is smaller than the first length 140. In some embodiments, the second length is about 1 inch to about 6 inches. In some embodiments, the first length is about 2 inches to about 24 inches.

The rod 102 may be made of any suitable rigid material able to withstand the forces applied during use as described herein, such as a metal, for example, steel, or the like. In some embodiments, the rod 102 is about 4 inches to about 60 inches long. In some embodiments, the rod is about 4 inches to about 30 inches long. In some embodiments, a central portion 120 of the rod 102 is unthreaded. In some embodiments, an outer diameter 130 of the rod is about 0.375 inches to about 1 inch.

A drive feature 110 is coupled to the rod 102 proximate the second end 108 as compared to the first end 106. The drive features 110 may be any suitable feature that facilitates driving the tool 100 into a pole (e.g., rotating the pole). For example, in some embodiments, the drive feature 110 comprises a nut coupled to the rod 102. In some embodiments, the nut is a square nut, a hex nut, or the like. The nut may be coupled to the rod 102 via internal threads of the nut that engage with the second threads 118. In some embodiments, the nut is welded to the rod 102. In some embodiments, the nut is a lock nut. In some embodiments, the nut is coupled to the rod 102 at a position suitable for engaging with a socket drill for driving the tool 100 into a pole. In some embodiments, the drive feature can be integrally formed on the rod 102 or can be welded, pinned, or otherwise permanently and immovably fixed to the rod 102.

A hook 115 is coupled to the rod 102 at the second end 108. The hook 115 may be removably coupled to the rod 102. The hook 115 generally provides an attachment region for pulling the tool 100 and any pole that is attached to the tool 100. In some embodiments, the hook 115 comprises an eye nut 125 removably coupled to the rod 102 at the second end 108 via the second threads 118. However, the hook 115 may comprise any other structure, such as an open hook, a snap link, a screw quick link, or the like. In some embodiments, the eye nut 125 includes a ring body 124 and internal threads 148 disposed within the ring body 124, wherein the internal threads 148 are configured to engage the second threads 118.

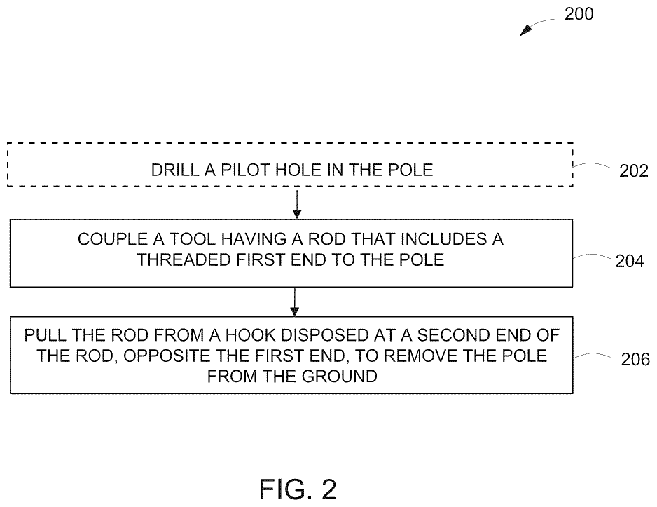

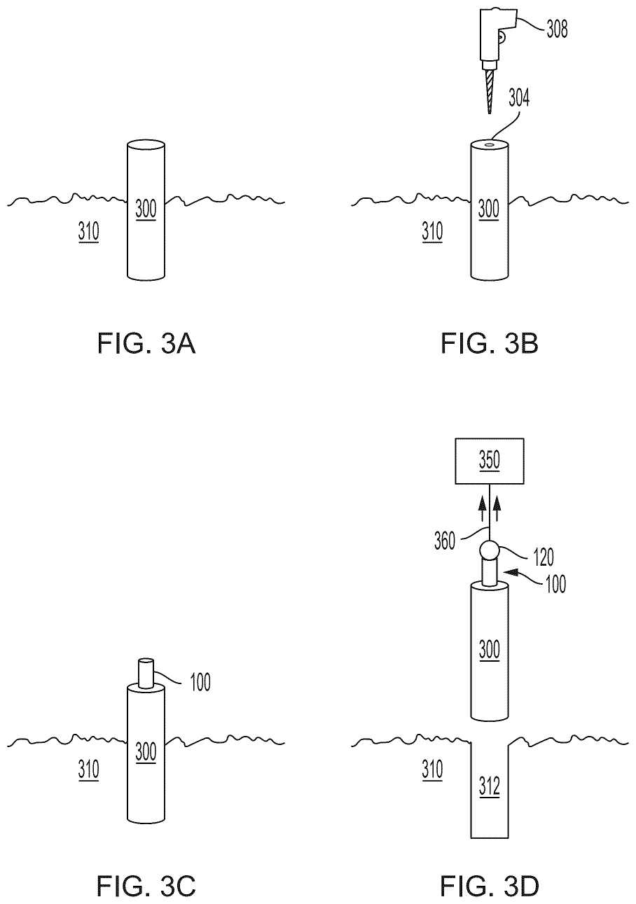

FIG. 2 depicts a flow chart of a method 200 of removing a pole (e.g., pole 300) from the ground in accordance with at least some embodiments of the present disclosure. FIG. 3A depicts a schematic side view of a pole 300 in the ground 310 in accordance with at least some embodiments of the present disclosure. The pole 300 may be a utility pole or any other suitable pole that is in the ground where digging around the pole to remove the pole may present a logistical or safety concern. The pole 300 may be made of wood, metal, cement, or other suitable material.

At 202, the method 200 optionally includes drilling a pilot hole (e.g., pilot hole 304) in the pole. FIG. 3B depicts a schematic side view of a pole 300 after drilling a pilot hole 304 in the pole 300 in the ground 310 in accordance with at least some embodiments of the present disclosure. The pilot hole may be drilled into any suitable surface of the pole 300. For example, in some embodiments, the pilot hole is drilled into a top surface of the pole so that the pole may advantageously be lifted vertically upwards to minimize disruptions to adjacent areas of the ground 310. In some embodiments, the pilot hole 304 is drilled via a drill 308. The pilot hole 304 may advantageously prevent cracking or splitting of the pole 300 when inserting the tool 100 into the pole 300.

In some embodiments, the method 200 further optionally comprises cutting the pole to shorten a distance that the pole extends from the ground prior to drilling the pilot hole or to screwing the tool 100 into the pole. For example, the pole may be cut to be a few feet from an upper surface of the ground to facilitate ease of handling the tool 100 and removal of the pole 300. For example, when removing a broken pole from the ground, cutting the pole can advantageously provide one or more of a more level surface or a more solid surface for inserting and retaining the tool 100 in the pole. In some embodiments, cutting the pole closer to the ground can advantageously provide a working surface (e.g., new upper surface) of the pole that is easier to reach and/or that provides greater range of motion for removal of the pole from the ground.

At 204, the method 200 includes coupling (e.g., inserting, screwing, or the like) a tool (e.g., tool 100) having a rod (e.g., rod 102) that includes a threaded first end (e.g., first threads 114) to the pole, and when present, into the pilot hole. The tool may be coupled to the upper surface of the pole or a sidewall of the pole. The screwing of the tool couples the tool to the pole. In some embodiments, the tool 100 can be inserted axially into the center of the pole, or to some point near the center of the pole. In some embodiments, the tool includes a drive feature (e.g., drive feature 110), such as a nut coupled to the rod. In some embodiments, screwing the tool comprises using a drill to rotate or drive the drive feature (e.g., drive feature 110) to screw the rod into the pole. In some embodiments, screwing the tool is performed via a socket drill, such as the drill 308. In some embodiments, screwing the tool may be done manually or with a hand tool via the drive feature 110 of the tool 100. FIG. 3C depicts a schematic side view of a pole 300 in the ground 310 after attaching the tool 100 to the pole 300 in accordance with at least some embodiments of the present disclosure.

At 206, the method 200 includes pulling the rod from a hook (e.g., hook 115) disposed at a second end (e.g., second end 108) of the rod, opposite the first end (e.g., first end 106) to remove the pole from the ground. For example, by pulling the rod after being secured to the pole, the tool transfers a force having an upward vector to facilitate removing the pole from the ground. In some embodiment, the lifting force applied has a predominantly upward direction, e.g., less than 45 degrees with respect to the elongate axis of the pole. In some embodiments, the hook is attached to the tool after screwing the tool into the pole. For example, the hook may be an open or closed hook such as an eye nut (e.g., eye nut 125) having threads that engage with second threads (e.g., second threads 118) of the rod.

Pulling the hook may be performed manually or via a pulling machine (e.g., machine 350). The pulling machine may be any suitable vehicle or tool configured to lift the pole 300 out of the ground 310 via the tool 100. The pulling machine may be standalone such as a cable or wire puller, or coupled to, or integrated with, a vehicle such as a truck. For example, in some embodiments, pulling the rod with the hook is performed with a truck such as a utility truck, work truck, a digger truck, an auger truck, a tow truck, or the like. In some embodiments, the method 200 comprises attaching a chain (e.g., chain 360), wire, cable, or the like to the hook prior to pulling on the hook. In some embodiments, one or more pulleys can be used to direct the force applied by the machine 350 in an upward (e.g., axial) direction with respect to the pole 300.

FIG. 3D depicts a schematic side view of a pole 300 being removed from the ground 310 in accordance with at least some embodiments of the present disclosure. The tool 100 is coupled to the pole 300. In some embodiments, and as depicted in FIG. 3D, the hook 115 is coupled to the tool 100 and the machine 350 is attached to the hook 115 via a chain 360 and configured to pull on the hook 115 to remove the pole 300 from the ground 310. In some embodiments, the machine 350 is configured to vertically lift the pole 300 out of the ground 310 to advantageously minimize the force required to remove the pole as well as to reduce or prevent disturbance of the ground 310 adjacent to a hole 312 for the pole 300. In some embodiments, the method 200 further includes removing the tool 100 from the pole 300, for example, after removing the pole 300 from the ground.

While the foregoing is directed to embodiments of the present disclosure, other and further embodiments of the disclosure may be devised without departing from the basic scope thereof.

1. A tool for removing a pole from the ground, comprising:
a rod having a first end and a second end, wherein the rod includes first threads at the first end that are configured for penetrating the pole and securing the rod to the pole;
a drive feature coupled to the rod proximate the second end; and
a hook disposed at the second end of the rod.

2. The tool of claim 1, wherein the rod is about 4 inches to about 60 inches long.

3. The tool of claim 1, further comprising second threads disposed at the second end.

4. The tool of claim 3, wherein the first threads extend at a first angle with respect to an axis of the rod and the second threads extend at a second angle with respect to the axis of the rod, wherein the first angle is different than the second angle.

5. The tool of claim 3, wherein the hook comprises an eye nut removably coupled to the rod at the second end via the second threads.

6. The tool of claim 5, wherein the eye nut includes a ring body and internal threads disposed within the ring body, wherein the internal threads are configured to engage the second threads.

7. The tool of claim 1, wherein a central portion of the rod is unthreaded.

8. The tool of claim 1, wherein the drive feature comprises a nut coupled to the rod proximate the second end.

9. The tool of claim 1, wherein an outer diameter of the rod is about 0.375 inches to about 1 inch.

10. A tool for removing pole from the ground, comprising:
a rod having a first end and a second end, wherein the rod includes first threads at the first end having a pointy end configured for penetrating the utility pole, and wherein the rod includes second threads at the second end, wherein the first threads extend at a first angle with respect to an axis of the rod and the second threads extend at a second angle with respect to the axis of the rod, wherein the first angle is different than the second angle;
a nut coupled to the rod proximate the second end via the second threads; and
an eye nut removably coupled to the rod at the second end.

11. The tool of claim 10, wherein the eye nut includes internal threads configured to engage with the second threads.

12. The tool of claim 10, wherein the rod is about 4 inches to about 60 inches long.

13. The tool of claim 10, wherein the first threads extend along a first length of the rod and the second threads extend along a second length of the rod, wherein the second length is smaller than the first length.

14. A method of removing a pole from the ground, comprising:
coupling a tool having a rod that includes a threaded first end into the pole; and
pulling the rod from a hook disposed at a second end of the rod, opposite the first end, to remove the pole from the ground.

15. The method of claim 14, wherein pulling the rod from the hook is performed with a truck.

16. The method of claim 14, further comprising attaching a chain, wire, or cable to the hook prior to pulling on the hook.

17. The method of claim 14, wherein the tool includes a nut coupled to the rod, wherein the nut is disposed about 1 to about 6 inches from the second end.

18. The method of claim 14, further comprising cutting the pole to shorten a distance that the pole extends from the ground prior to coupling the tool to the pole.

19. The method of claim 14, further comprising drilling a pilot hole in the pole prior to coupling the tool to the pole.

20. The method of claim 19, wherein the pole is a utility pole and the pilot hole is drilled into a top surface of the pole.
